(19) United States
(12) Patent Application Publication
(10) Pub. No.: US 2010/0149254 A1
(43) Pub. Date: Jun. 17, 2010

(54) LIQUID EJECTING HEAD AND LIQUID EJECTING APPARATUS

(75) Inventors: Mikiya YAJIMA, Shiojiri-shi (JP); Shinichi TSUBOTA, Azumino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/635,221

(22) Filed: Dec. 10, 2009

(30) Foreign Application Priority Data
Dec. 11, 2008 (JP) 2008-315236

(51) Int. Cl. B41J 2/145

(52) U.S. Cl. 347/40

(57) ABSTRACT

A liquid ejecting head including a plurality of nozzle groups, a plurality of reservoirs, each of which corresponds to each nozzle group, each reservoir having an introduction port, wherein the reservoirs include a first reservoir in which the introduction port is disposed in the center of the reservoir in the nozzle row direction and a second reservoir in which the introduction port offset from the center of the reservoir, and wherein a liquid having a pressure P comparatively higher than those of other liquids among plurality types of liquids ejected from the liquid ejecting head is introduced into the first reservoir.

### CROSS-REFERENCES AND RELATED APPLICATIONS

The entire disclosures of Japanese Patent Application No. 2008-315236, filed Dec. 11, 2008 is expressly incorporated herein by reference.

### BACKGROUND OF THE INVENTION

1. Technical Field

The present invention relates to a liquid ejecting head such as an ink jet printing head and a liquid ejecting apparatus. More particularly, the present invention relates to a liquid ejecting head and a liquid ejecting apparatus capable of suppressing ejection errors during a high duty ejection operation and improving discharging performance.

2. Related Art

A liquid ejecting apparatus is an apparatus known in the art which includes a liquid ejecting head which is capable of ejecting a liquid, and ejects various liquids from the liquid ejecting head. An example a liquid ejecting apparatus known in the art is, for example, an image printing apparatus such as an ink jet printing apparatus or printer which includes an ink jet printing head (hereinafter, referred to as a printing head) which ejects liquid ink so as to perform a printing process. In recent years, the liquid ejecting apparatus has also come to include various manufacturing apparatuses other than the image printing apparatus, such as a display manufacturing apparatus.

The printing head is capable of ejecting plurality of different types or colors of ink. The printing head includes a nozzle row (nozzle group) which is formed by disposing a plurality of nozzles in rows and a reservoir or common ink chamber which supplies ink to the nozzles of the nozzle rows, where pairs of the nozzle rows and reservoirs are provided for each color of the ink. Each of the reservoirs is provided with an introduction port to which the ink is supplied from an ink supply source such as an ink cartridge. The introduction port is disposed in a limited space of the printing head because of increased demand for a printing head with a reduced size or the specific configuration of the wiring layout of a wiring used to apply a driving signal to a pressure generating chamber. For this reason, in some cases, the introduction port has to be disposed at a position deviated from the center of the reservoir in the nozzle row direction, such as for example, in the example shown in FIGS. 3 and 7 of Japanese Patent Ref. No. JP-A-2006-281477.

When the introduction port is disposed at a position deviated from the center of the reservoir, since the distance between the nozzle located at one end of the nozzle row and the introduction port is different from the distance between the nozzle located at the other end of the nozzle row and the introduction port, there is a difference in the pressure loss in the nozzle rows due to a difference in the passageway resistance. The difference in the pressure loss becomes even larger, for example, when a high duty ejection driving operation is performed in which plurality nozzles in the nozzle row simultaneously eject ink and consume more ink. Due to the difference in the pressure loss, the discharging performance may deteriorate at the nozzle located at the end of the nozzle row, that is, the nozzle located at a position more distant from the introduction port may not have sufficient pressure to perform a proper ejection process.

In addition, during the ejection driving operation of ejecting the ink from the nozzle, a pressure (negative pressure) for returning the ink to the ink supply source is generated in the head passageway. The pressure becomes large when the high duty ejection driving operation in which plurality nozzles in the nozzle row simultaneously eject ink and consume more ink. That is, because a negative pressure is generated in the ink supply source as a large number of ink is ejected, the meniscus of the ink in the nozzle is excessively drawn to the pressure generating chamber, creating bubbles in the pressure generating chamber. The contained bubbles may cause the ink ejection operation to be unstable. In addition, in the case where the introduction port is disposed at a position deviated from the center of the reservoir, an ejection error may be easily generated at the nozzle disposed at a position more distant from the introduction port due to the excessively drawn meniscus of the ink.

### BRIEF SUMMARY OF THE INVENTION

An advantage of some aspects of the invention is that it provides a liquid ejecting head and a liquid ejecting apparatus capable of suppressing ejection error during a high duty ejection operation and improving a bubble discharging performance.

A first aspect of the invention is liquid ejecting head comprising a plurality of nozzle groups which are formed by arranging a plurality of nozzles which eject a liquid into rows, a plurality of reservoirs, each of which corresponds to a nozzle group so as to communicate with each of the nozzles of the corresponding nozzle group, and an introduction port which communicates with each of the reservoirs so as to supply a liquid to each of the plurality of reservoirs. The plurality of reservoirs include a first reservoir in which the introduction port is disposed at the center of the reservoir in the nozzle row direction, and a second reservoir in which the introduction port is disposed further towards the end of the reservoir in the nozzle row direction as compared with the first reservoir. The pressure P shown in a following equation (1) is obtained at the introduction port when a predetermined number of nozzles of the nozzle groups eject the liquid for a predetermined period of time, the liquid having the highest pressure P among plurality types of liquids ejected from the liquid ejecting head is introduced into the first reservoir, and wherein the equation (1) is expressed as P=Q×R, where Q denotes a flow rate of the liquid measured at the introduction port which is equal to the result of a weight (ng) of each ejected liquid droplet×an ejection frequency (Hz)×the number of nozzles (n number) used for an ejection operation, and where R denotes a passageway resistance measured at the introduction port which is equal to 128×a liquid viscosity (Pa·s)×a length (μm) of the introduction port/(π×(the fourth power of a diameter (μm) of the circular introduction port).

According to the above-described configuration, when the liquid having the pressure P shown in the equation (1) and higher than those of other liquids is allocated to the first reservoir, it is possible to suppress ejection error during the high duty driving operation. That is, as the pressure P of the liquid becomes higher, the meniscus is more easily drawn to the opposite side of the ejection side at the high duty driving operation in which plurality (for example, more than half of) nozzles in the same nozzle row eject the liquid. Particularly, the drawn meniscus can be clearly observed at the nozzle located at a position more distant from the introduction port. Due to the drawn meniscus, ejection error may be caused by the contained bubbles. Accordingly, when the liquid having the pressure P higher than those of other liquids is introduced into the first reservoir in which a difference in the pressure loss is comparatively small, it is possible to prevent the meniscus at the particular nozzle located at the end of the nozzle row from being excessively drawn during the high duty driving operation. Accordingly, it is possible to suppress ejection error.

In addition, since it is possible to reduce the difference in the pressure loss between the nozzles, it is possible to improve the discharging performance at the nozzle located at the end of the nozzle row.

### BRIEF DESCRIPTION OF THE DRAWINGS

The invention will be described with reference to the accompanying drawings, wherein like numbers reference like elements.

FIG. 1 is a sectional view illustrating a printing head;

FIG. 2 is a sectional view illustrating a main part of a head unit; and

FIG. 3 is a plan view illustrating an arrangement layout of a reservoir and an ink introduction port.

### DESCRIPTION OF EXEMPLARY EMBODIMENTS

Hereinafter, an embodiment of the invention will be described with reference to the accompanying drawings. In the embodiment described below, various limitations are described as the exemplary detailed examples of the invention, but the scope of the invention is not limited thereto as long as no particular limitation is made in the following description. Further, in the following description, an ink jet printing head (hereinafter, simply referred to as “a printing head”) loaded on an ink jet printer (which is a kind of a liquid ejecting apparatus) will be exemplified as an example of a liquid ejecting head according to the invention.

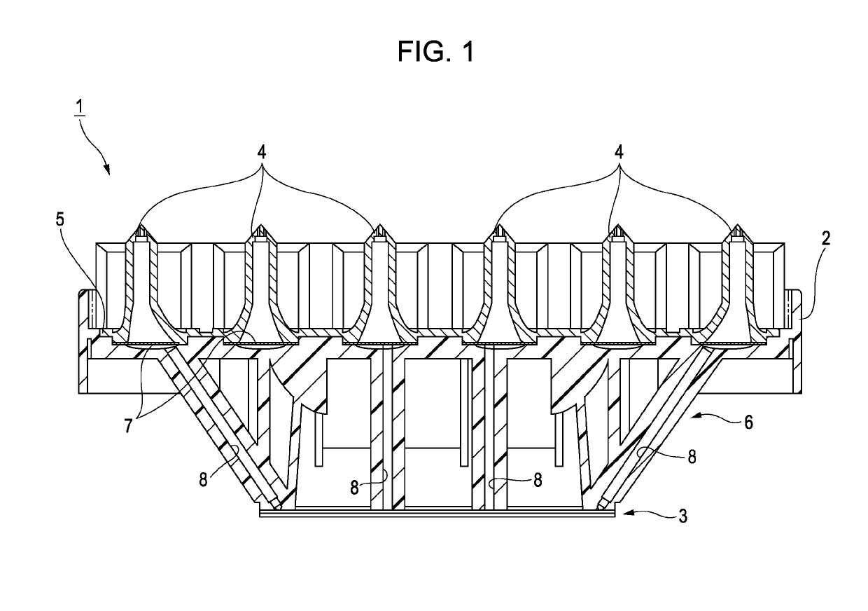

FIG. 1 is a sectional view illustrating a printing head 1 according to the exemplary embodiment of the invention. The printing head 1 shown in FIG. 1 is used to print an image or the like on a landing target, such as, for example, a printing sheet, by ejecting ink or other liquid. The printing head includes a head unit 3 and an ink introduction needle 4, which are attached to a head casing 2.

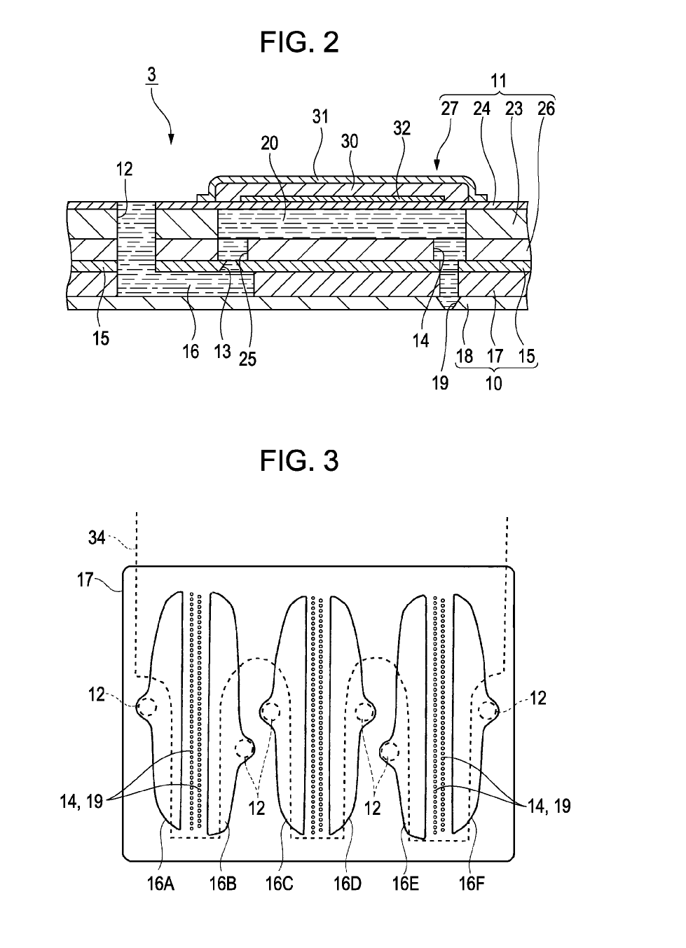

The head casing 2 is formed by an injection molding process using, for example, a synthetic resin or the like, and includes a base portion 5 to which plurality ink introduction needles 4 are attached and a hollow box-shaped passageway forming portion 6 which extends from the base portion 5 to the opposite side of the attachment position of the ink introduction needles. The base portion 5 has arrangement portions defined therein so as to respectively arrange ink cartridges (not shown), which act as a kind of a liquid supply source, therein. The ink introduction needles 4 are respectively attached to the arrangement portions. In this embodiment, the head casing 2 includes a total of six ink introduction needles 4. Each of the ink introduction needles 4 is a hollow needle-shaped member with a front end which is formed in a conical shape so as to be sharp, and which has an ink introduction hole (not shown) so as to introduce ink into the needle. When the ink introduction needle 4 is inserted into the cartridge, the ink stored inside the cartridge is introduced to a reservoir 16 (see FIGS. 2 and 3) of the printing head 1 through the ink introduction hole. That is, in this embodiment, because there are six ink introduction needles, the printing head 1 is capable of ejecting six colors of ink. Although this embodiment includes an ink cartridge, it is possible to adopt a configuration where the ink cartridge is attached to a carriage loaded with the printing head 1 or a type in which the ink cartridge is attached to a casing of a printer so as to introduce ink to the printing head 1 through an ink supply tube.

The passageway forming portion 6 is provided with plurality (i.e., six, in this embodiment) ink supply paths 8 which correspond to the ink introduction needles 4 and supply the ink introduced from the ink introduction needles 4 to pressure generating chambers 20 (see FIG. 2) of the head unit 3. A filter 7 is disposed between each of the ink introduction needles 4 and each upstream end of the ink supply paths 8 so as to filter and separate foreign materials or bubbles existing inside the passageway. In addition, a flexible cable (not shown) or the like is accommodated in the passageway forming portion 6 so as to supply a driving signal from the printer loaded with the printing head 1 to a piezoelectric vibrator (see FIG. 2).

FIG. 2 is a sectional view illustrating a main part of the head unit 3. In this embodiment, the head unit 3 includes a passageway unit 10 and a pressure generating unit 11.

The passageway unit 10 includes a supply port formation substrate 15 which has perforation holes which are used as a part of an ink introduction port 12 along with an ink supply port 13 and a nozzle communication port 14. The passageway unit 10 also includes a reservoir formation substrate 17 which has perforation holes which are used as perforation holes of the reservoir 16, which forms a common ink chamber, and a part of the nozzle communication port 14. Furthermore, the passageway unit 10 also includes a nozzle formation substrate 18 which has plurality nozzle rows formed by disposing a plurality of nozzles 19 in rows. The supply port formation substrate 15, the reservoir formation substrate 17, and the nozzle formation substrate 18 are formed by performing a pressing process on, for example, a stainless plate member. In addition, the passageway unit 10 is formed in such a manner that the nozzle formation substrate 18 is disposed on one surface (the lower surface shown in FIG. 2) of the reservoir formation substrate 17, while the supply port formation substrate 15 is disposed on the other surface (the upper surface shown in FIG. 2), with the nozzle formation substrate 18, the reservoir formation substrate 17, and the supply port formation substrate 15 being bonded to each other in a laminated state.

The pressure generating unit 11 includes a pressure generating chamber formation substrate 23 which has perforation holes which form both a portion of the ink supply port 12 and a portion of the pressure generating chamber 20, a vibration plate 24 which has a perforation hole which forms a portion of the ink supply port 12 and defines a part of the pressure generating chamber 20, a communication port substrate 26 which has a perforation hole which forms a portion of the ink supply port 12 and communication holes which are used as a part of a supply-side communication hole 25 and the nozzle communication port 14, and a piezoelectric vibrator 27 (which is a kind of a pressure generating element).

The pressure generating unit 11 is formed in such a manner that the communication port substrate 26 is disposed on one surface of the pressure generating chamber formation substrate 23, while the vibration plate 24 is disposed on the other surface, and the piezoelectric vibrator 27 is disposed on the surface of the vibration plate 24. In the respective constituents, the pressure generating chamber formation substrate 23, the vibration substrate 24, and the communication port substrate 26 are formed of ceramics such as alumina or oxide zirconium, and are bonded by a burning process.

The piezoelectric vibrator 27 is a so-called flexure mode piezoelectric vibrator, and is provided for each pressure generating chamber 20 and is disposed on the surface of the vibration plate 24 on the opposite side of the pressure generating chamber 20. The piezoelectric vibrator 27 has a multilayer structure formed by a piezoelectric body layer 30, a driving electrode 31, and a common electrode 32, where the piezoelectric body layer 30 is interposed between the driving electrode 31 and the common electrode 32. The driving electrode 31 is electrically connected to a driving signal supply source (not shown) through a wiring member 34 (see FIG. 3). In addition, the common electrode 32 is adjusted to, for example, a ground potential. When the driving signal is supplied to the driving electrode 31, an electric field is formed between the driving electrode 31 and the common electrode 32 in accordance with the difference in the potential. The electric field is applied to the piezoelectric body layer 30, and the piezoelectric body layer 30 is deformed in accordance with the magnitude of the electric field applied to the piezoelectric body layer 30. That is, as the potential of the driving electrode 31 increases, the piezoelectric body layer 30 contracts in a direction perpendicular to the electric field, and deforms the vibration plate 24 so as to decrease the volume of the pressure generating chamber 20.

A series of separate passageways are provided for each nozzle 19 in the head unit 3 so as to communicate the reservoir 16 with the nozzle 19 through the ink supply port 13, the supply-side communication port 25, the pressure generating chamber 20, and the nozzle communication port 14. In addition, as shown in FIG. 3, the head unit 3 of this embodiment is provided with six reservoirs 16A-16F, collectively referred to as reservoirs 16, each of which corresponds to the six ink introduction needles 4. A ink introduction port 12 is provided for each of the reservoirs 16. Further, when the head unit 3 is bonded to the front surface of the head casing 6, opposite to the ink introduction needles, the ink supply path 8 on the side of the head casing 6 is liquid-tightly connected to the ink introduction port 12 on the side of the head unit 3. Accordingly, an ink passageway (which is a kind of a liquid passageway) is formed by communicating the ink introduction needle 4, the ink supply path 8, and the head passageway with each other, thereby supplying the ink from the ink introduction needle 4 to the reservoir 16 through the ink supply path 8.

As shown in FIG. 3, a reservoir 16 is provided for each color of the ink. In addition, the ink introduction port 12 for introducing the ink to each of the reservoirs 16A-16F is disposed in a limited space due to a reason such as a demand for a decrease in the size of the printing head 1 or the wiring layout of the wiring member 34. For this reason, in some cases, the ink introduction port 12 has to be disposed at a position deviated from the center of the reservoir 16, ejecting the ink, in a direction where the nozzles are formed in rows (in the longitudinal direction of the reservoir). In this example, the ink introduction ports 12 are respectively disposed on the side of the ink introduction ports 12 between the reservoirs 16B and 16C and between the reservoirs 16D and 16E when the ink introduction ports 12 face each other, and are deviated from each other in the nozzle row direction so that the ink introduction ports 12 do not overlap each other. In addition, in the reservoirs 16A, 16C, 16D, and 16F (which correspond to the first reservoirs in the invention), each of the ink introduction ports 12 is disposed at the center in the nozzle row direction. However, in the reservoirs 16B and 16E (which correspond to the second reservoirs in the invention), each of the ink introduction ports 12 is disposed at a position deviated from the center in the nozzle row direction (so as to be close to the end of the nozzle row direction compared with the case of the first reservoirs).

When the ink introduction port 12 is disposed at a position deviated from the center of the reservoir 16, in the nozzle row corresponding to the reservoir 16 (16B and 16E), the distance between the nozzle 19 located at one end (the upper side in FIG. 3) of the nozzle row and the ink introduction port 12 is different from the distance between the nozzle 19 located at the other end (the lower side in FIG. 3) of the nozzle row and the ink introduction port 12. That is, in this example, the distance between the nozzle 19 located at one end of the nozzle row and the ink introduction port 12 is longer than the distance between the nozzle 19 located at the other end of the nozzle row and the ink introduction port 12. For this reason, the difference in the pressure loss becomes large due to the difference in the passageway resistance between the nozzles. Due to the difference in the pressure loss, the bubble discharging performance may deteriorate at the nozzle 19 located at the end of the nozzle row, that is, the nozzle 19 located at a position more distant from the ink introduction port 12.

During the ejection driving operation where ink is ejected from the nozzle 19, a pressure (negative pressure) for returning the ink to the ink supply source (in this embodiment, the ink cartridge) is generated in the head passageway in addition to a pressure generated by the operation of driving the piezoelectric vibrator 27. The pressure becomes large in the case of the high duty ejection driving operation in which plurality nozzles in the nozzle row simultaneously eject ink and consume more ink. That is, this is because a negative pressure is generated in the ink supply source as the large amount of ink is ejected. Due to the pressure, the meniscus of the ink in the nozzle 19 is excessively drawn to the pressure generating chamber. Accordingly, the ink ejection operation may be unstable due to the involved bubbles. In addition, when the ink introduction port 12 is disposed at a position deviated from the center of the reservoir 16, an ejection error may be easily generated at the nozzle 19 disposed at a position more distant from the ink introduction port 12 due to the excessively drawn meniscus of the ink. As a result, it can be seen that the degree to which the meniscus can withstand the pressure generated at the ejection driving operation is different in accordance with the type of the ink (liquid).

Therefore, in the printing head 1 according to the invention, when a predetermined number of nozzles 19 in the nozzle row eject the ink for a predetermined period of time, the pressure P obtained at the ink introduction port 12 and shown in the following equation (1) is calculated, and the allocation of the ink and the reservoir 16 is determined on the basis of the pressure P, that is, the pressure P as an index. More specifically, in consideration of the relationship between the pressure P and plurality of different types of ink, that is, any color of ink ejected from the printing head 1, when the ink introduction port 12 is disposed at the center in the longitudinal direction of the reservoir, the ink having the pressure P which is comparatively higher than those of other colors of ink is introduced into any one of the reservoirs 16A, 16C, 16D, and 16F as the first reservoir. On the other hand, the ink having the pressure P which is comparatively lower than those of other colors of ink is introduced into any one of the second reservoir 16B and the fifth reservoir 16E as the second reservoir.

P=Q×R (1)

Here, Q denotes a flow rate of the ink measured at the ink introduction port 12 and expressed as “the weight (ng) of each ejected ink droplet×the ejection frequency (Hz)×the number of nozzles (n number) used for the ejection operation”, and R denotes the passageway resistance measured at the ink introduction port 12 and expressed as “(128×the ink viscosity (Pa·s)×the length (μm) of the ink introduction port 12)/(π×(the fourth power of the diameter (μm) of the circular ink introduction port 12)).”

Further, the ejection frequency f (Hz) is expressed as the number of ejection times per hour. In addition, the sign in the parenthesis denotes the unit.

Likewise, when the ink having the pressure P shown in the equation (1) which is higher than those of other ink is allocated to the first reservoir, it is possible to suppress ejection error during the high duty driving operation. As the pressure P of the ink becomes higher, the meniscus is more easily drawn to the pressure generating chamber side of the ejection side at the high duty driving operation. Particularly, the drawn meniscus is clearly observed at the nozzle 19 located at a position more distant from the ink introduction port 12. Accordingly, when the ink having the pressure P higher than those of other inks is introduced into the first reservoir at which the ink introduction port 12 is disposed on the center in the nozzle row direction, it is possible to prevent the meniscus at the particular nozzle 19 located at the end of the nozzle row from being excessively drawn at the high duty driving operation. Accordingly, it is possible to suppress a problem in the ejection operation caused by the excessively drawn meniscus of the ink. In addition, since it is possible to reduce a difference in the pressure loss between the nozzles, it is possible to suppress the ink from being delayed at both ends of the reservoir 16 in the nozzle row direction, and thus to improve the discharging performance at the nozzle 19 located at the end of the nozzle row.

However, the invention is not limited to the above-described embodiment, but may be modified into various forms without departing from the meaning and scope of the claims.

For example, in the above-described embodiment, the so-called flexure mode piezoelectric vibrator 27 is adopted, but the invention is not limited thereto. For example, a so-called vertical vibration mode piezoelectric vibrator may be adopted. In addition, the invention is not limited to the piezoelectric vibrator, but may adopt other ejection driving sources such as a heating element.

Further, although the shape, the number, or the arrangement layout of the reservoir 16 is described in the above-described embodiment, the invention is not limited to the examples shown in the above-described embodiment.

Furthermore, the arrangement position of the ink introduction port 12 with respect to the first reservoir (in the above-described embodiment, the reservoirs 16A, 16C, 16D, and 16F) is not limited to the center in the nozzle row direction, but may be located at a position close to the center compared with the arrangement position of the ink introduction port 12 with respect to the second reservoir (in the above-described embodiment, the reservoirs 16B and 16E).

Moreover, the invention may be applied to a liquid ejecting apparatus for ejecting a liquid other than ink. That is, the invention may be applied to the liquid ejecting apparatus, for example, a display manufacturing apparatus, an electrode manufacturing apparatus, a chip manufacturing apparatus, and the like which eject various liquid materials such as color materials or electrodes.

What is claimed is:

1. A liquid ejecting head comprising:
a plurality of nozzle groups which are formed by arranging a plurality of nozzles which eject a liquid into rows;
a plurality of reservoirs, each of which corresponds to a nozzle group so as to communicate with each of the nozzles of the corresponding nozzle group; and
an introduction port which communicates with each of the reservoirs so as to supply a liquid to each of the plurality of reservoirs,
wherein the plurality of reservoirs includes:
a first reservoir in which the introduction port is disposed at the center of the reservoir in the nozzle row direction; and
a second reservoir in which the introduction port is disposed further towards the end of the reservoir in the nozzle row direction as compared with the first reservoir, and
wherein a pressure P shown in a following equation (1) is obtained at the introduction port when a predetermined number of nozzles of the nozzle groups eject the liquid for a predetermined period of time, the liquid having the highest pressure P among plurality types of liquids ejected from the liquid ejecting head is introduced into the first reservoir, and wherein the equation (1) is expressed as P=Q×R, where Q denotes a flow rate of the liquid measured at the introduction port which is equal to the result of a weight (ng) of each ejected liquid droplet×an ejection frequency (Hz)×the number of nozzles (n number) used for an ejection operation, and where R denotes a passageway resistance measured at the introduction port which is equal to 128×a liquid viscosity (Pa·s)×a length (μm) of the introduction port/(π×(the fourth power of a diameter (μm) of the circular introduction port).

2. The liquid ejecting head according to claim 1,
wherein the first and second reservoirs are respectively disposed on a side of the introduction ports so that the introduction ports face each other.

3. The liquid ejecting head according to claim 1, further comprising a third reservoir, wherein the introduction port of the third reservoir is disposed at the center of the first reservoir in the nozzle row direction.

4. A liquid ejecting apparatus comprising:
a liquid ejecting head including:
a plurality of nozzle groups which is formed by arranging a plurality of nozzles which eject a liquid into rows;
a plurality of reservoirs, each of which corresponds to one of the plurality of nozzle groups so as to communicate with each of the nozzles of the corresponding nozzle group; and
an introduction port which communicates with each of the reservoirs so as to supply a liquid to the corresponding reservoir,
wherein the reservoirs include:
a first reservoir where the introduction port is disposed in the center of the reservoir in the nozzle row direction; and
a second reservoir in which the introduction port is disposed closer to the end of reservoir the nozzle row direction as compared with the case of the first reservoir, and
wherein a pressure P shown in a following equation (1) is obtained at the introduction port when a predetermined number of nozzles of the nozzle groups eject the liquid for a predetermined period of time, the liquid having the highest pressure P among plurality types of liquids ejected from the liquid ejecting head is introduced into the first reservoir, and wherein the equation (1) is expressed as P=Q×R, where Q denotes a flow rate of the liquid measured at the introduction port which is equal to the result of a weight (ng) of each ejected liquid droplet×an ejection frequency (Hz)×the number of nozzles (n number) used for an ejection operation, and where R denotes a passageway resistance measured at the introduction port which is equal to 128×a liquid viscosity (Pa·s)×a length (μm) of the introduction port/(π×(the fourth power of a diameter (μm) of the circular introduction port).

5. A liquid ejecting head comprising:
a plurality of nozzle groups which are formed by arranging a plurality of nozzles which eject a liquid into rows;
a plurality of reservoirs, each of which corresponds to a nozzle group so as to communicate with each of the nozzles of the corresponding nozzle group; and
an introduction port which communicates with each of the reservoirs so as to supply a liquid to each of the plurality of reservoirs,
wherein the plurality of reservoirs includes:
a first reservoir in which the introduction port is disposed at the center of the reservoir in the nozzle row direction;
a second reservoir in which the introduction port is disposed further towards the end of the reservoir in the nozzle row direction as compared with the first reservoir; and
a third reservoir in which the introduction port is disposed at the center of the reservoir in the nozzle row direction;
wherein the second reservoir is formed adjacent to the third reservoir so that the introduction port of the third reservoir faces the introduction port of the second reservoir while deviating from each other in the nozzle row direction so that their ink introduction ports do not overlap, and
wherein a pressure P shown in a following equation (1) is obtained at the introduction port when a predetermined number of nozzles of the nozzle groups eject the liquid for a predetermined period of time, the liquid having the highest pressure P among plurality types of liquids ejected from the liquid ejecting head is introduced into the first reservoir, and wherein the equation (1) is expressed as P=Q×R, where Q denotes a flow rate of the liquid measured at the introduction port which is equal to the result of a weight (ng) of each ejected liquid droplet×an ejection frequency (Hz)×the number of nozzles (n number) used for an ejection operation, and where R denotes a passageway resistance measured at the introduction port which is equal to 128×a liquid viscosity (Pa·s)×a length (μm) of the introduction port/(π×(the fourth power of a diameter (μm) of the circular introduction port).
